(19) United States
(12) Patent Application Publication
(10) Pub. No.: US 2004/0096986 A1
(43) Pub. Date: May 20, 2004

(54) Pharmaceutical combi-chem purification factory system

(76) Inventors: Kenneth J. Klein, Newark, DE (US); Kimber D. Fogelman, Hockessin, DE (US); Vincent L. Worley, Wilmington, DE (US); Terry A. Berger, Englewood, FL (US)

Correspondence Address: ZITO TLP, 26005 RIDGE ROAD, SUITE 203, DAMASCUS, MD, 20872, US

(21) Appl. No.: 10/705,940

(22) Filed: Nov. 13, 2003

Related U.S. Application Data
(60) Provisional application No. 60/425,625, filed on Nov. 13, 2002.

(51) Int. Cl. G01N 33/558; C02F 1/28; B01D 15/08

(52) U.S. Cl. 436/514; 210/656

(57) ABSTRACT

The invention relates to a system for sample fi-action collection in chromatography, and more specifically for using an extended vessel assembly that increases the total collectible volume of a liquid sample fraction in a single collection vessel in an automated system for collection, purification, and storage of purified sample fractions. The system uses an extended vessel assembly to provide collection of substantially large volumes of liquid fractions from chromatography system, such as a preparatory scale supercritical fluid chromatography (Prep Scale SFC) or preparatory scale liquid chromatography (Prep Scale LC), into a single collection vessel. The invention improves productivity while reducing the need for sample transfer between vessels and reducing the risk of human error. The collected liquid solvent is removed after purification using one of several types of evaporation devices or techniques, such as evaporation at moderate temperature under a vacuum with liquid agitation. Collection vessels are labeled and grouped into labeled racks for tracking, efficient movement between system modules, and storage.

### STATEMENT OF PRIORITY

This application claims the benefit of related application No. 60/425,625, filed on Nov. 13, 2002.

### FIELD OF THE INVENTION

The invention relates to a system for sample fraction collection in chromatography, and more specifically for using an extended vessel assembly that increases the total collectible volume of a liquid sample fraction in a single collection vessel in an automated system for collection, purification, and storage in preparatory scale chromatography, such as supercritical fluid chromatography or liquid chromatography.

### BACKGROUND OF THE INVENTION

A substantial need exists for industries to recover purified components of interest from samples containing simple or complex mixtures of components. Many technologies have been developed to meet this need. For dissolvable, nonvolatile components, the technology of choice has been liquid elution chromatography.

Analysts have several objectives in employing preparative elution chromatography. First, they wish to achieve the highest available purity of each component of interest. Second, they wish to recover the maximum amount of the components of interest. Third, they wish to process sequential, possibly unrelated samples as quickly as possible and without contamination from prior samples. Finally, it is frequently desirable to recover samples in a form that is rapidly convertible either to the pure, solvent-free component or to a solution of known composition which may or may not include the original collection solvent.

In the case of normal phase chromatography, where only organic solvents or mixtures are used as eluants, typical fraction volumes of tens to hundreds of millimeters are common. The fraction must then be evaporated over substantial time to recover the component residues of interest. In reversed phase chromatography, where mixtures of organic solvents and water are used as the elution mobile phase, a secondary problem arises. After removal of lower boiling solvents, recovered fractions must undergo a water removal step lasting from overnight to several days. Thus, availability of the recovered components of interest is delayed by hours or days, even after the separation process is complete. This latter problem can create a serious bottleneck in the entire purification process when enough samples are queued.

Where difficult separation conditions exist or separation speed is a requirement, a subset of elution chromatography, known as high performance liquid chromatography (HPLC), is preferred. This HPLC technique is used both as an analytical means to identify individual components and as a preparative means of purifying and collecting these components.

For analytical HPLC, samples with component levels in the nanogram to microgram range are typical. Preparative HPLC systems typically deal with microgram to multiple gram quantities of components per separation. Preparative HPLC systems also require a means to collect and store individual fractions. This is commonly performed, either manually or automatically, simply by diverting the system flow stream to a series of open containers. Drawbacks exist to the current use of preparative HPLC. Elution periods ranging from several minutes to hours are necessary for each sample. Further, even in optimal conditions only a small fraction of the mobile phase contains components of interest. This can lead to very large volumes of waste mobile phase being generated in normal operation of the system.

An alternative separation technology called supercritical fluid chromatography (SFC) has advanced over the past decade. SFC uses highly compressible mobile phases, which typically employ carbon dioxide (CO2) as a principle component. In addition to CO2, the mobile phase frequently contains an organic solvent modifier, which adjusts the polarity of the mobile phase for optimum chromatographic performance. Since different components of a sample may require different levels of organic modifier to elute rapidly, a common technique is to continuously vary the mobile phase composition by linearly increasing the organic modifier content. This technique is called gradient elution.

SFC has been proven to have superior speed and resolving power compared to traditional HPLC for analytical applications. This results from the dramatically improved diffusion rates of solutes in SFC mobile phases compared to HPLC mobile phases. Separations have been accomplished as much as an order of magnitude faster using SFC instruments compared to HPLC instruments using the same chromatographic column. A key factor to optimizing SFC separations is the ability to independently control flow, density and composition of the mobile phase over the course of the separation.

SFC instruments used with gradient elution also reequillibrate much more rapidly than corresponding HPLC systems. As a result, they are ready for processing the next sample after a shorter period of time. A common gradient range for gradient SFC methods might occur in the range of 2% to 60% composition of the organic modifier.

SFC instruments, while designed to operate in regions of temperature and pressure above the critical point of CO2, are typically not restricted from operation well below the critical point. In this lower region, especially when organic modifiers are used, chromatographic behavior remains superior to traditional HPLC and often cannot be distinguished from true supercritical operation.

In analytical SFC, once the separation has been performed and detected, the highly compressed mobile phase is directed through a decompression step to a flow stream. During decompression, the CO2 component of the mobile phase is allowed to expand dramatically and revert to the gas phase. The expansion and subsequent phase change of the CO2 tends to have a dramatic cooling effect on the waste stream components. If care is not taken, solid CO2, known as dry ice, may result and clog the waste stream. To prevent this occurrence, heat is typically added to the flow stream. At the low flow rates of typically analytical systems only a minor amount of heat is required.

While the CO2 component of the SFC mobile phase converts readily to a gaseous state, moderately heated liquid organic modifiers typically remain in a liquid phase. In general, dissolved samples carried through SFC system also remain dissolved in the liquid organic modifier phase.

The principle that simple decompression of the mobile phase in SFC separates the stream into two fractions has great importance with regard to using the technique in a preparative manner. Removal of the gaseous CO2 phase, which constitutes 50% to 95% of the mobile phase during normal operation, greatly reduces the liquid collection volume for each component and thereby reduces the post-chromatographic processing necessary for recovery of separated components. The fact that common modifiers that are used in SFC use straight organics also further simplifies SFC sample collections, as well as greatly shortening dry-down time.

A second analytical purification technique similar to SFC is supercritical fluid extraction (SFE). Generally, in this technique, the goal is to separate one or more components of interest from a solid matrix. SFE is a bulk separation technique, which does not necessarily attempt to separate individually the components, extracted from the solid matrix. Typically, a secondary chromatographic step is required to determine individual components. Nevertheless, SFE shares the common goal with prep of SFC of collecting and recovering dissolved components of interest from a supercritical flow stream. As a result, a collection device suitable for preparative SFC should also be suitable for SFE techniques.

Expanding the technique of analytical SFC to allow preparative SFC requires several adaptations to the instrument. First the system requires increased flow capacity. Flows ranging from 20 ml/min to 200 ml/min are suitable for separation of multi-milligram up to gram quantities of materials. Also, a larger separation column is required. Finally, a collection system must be developed that will allow, at a minimum, collection of a single fraction of the flow stream which contains a substantially purified component of interest. In addition, there frequently exists a compelling economic incentive to allow multiple fraction collections from a single extracted sample. The modified system must also be able to be rapidly reinitialized either manually or automatically to allow subsequent sample injection followed by fraction collection.

Several commercial instances of preparative SFC instrumentation have been attempted which have employed different levels of technology to solve the problems of collection. A representative sampling of these products includes offerings from Gilson, Thar, Novasep, and ProChrome. However, no current implementation succeeds in providing high recovery, high purity, and low carryover from sample to sample. For example, one system may use the unsophisticated method of simply spraying the collection stream directly into a large bottle, which results in high sample loss, presumably due to aerosol formation. Another system uses a cyclonic separator to separate the two streams, but provides no rapid or automated means of washing the separators to prevent carryover. Such instruments are typically employed to separate large quantities of material by repetitive injection so that no sample-to-sample cleaning step is required. Other systems use a collection solvent to trap a sample fraction into a volume of special solvent in a collection container. This technique uses relatively large quantities of hazardous solvents to perform sample collection, is prone to sample fraction concentration losses or degradation, and possible matrix interferences exist between fractionated samples and collection solvent constituents.

In some cases, in the collection of liquid fractions from specific sample peaks in SFC, very large amounts of liquid are typically required for collection although this amount is far less than that required for HPLC due to both much narrower peak widths and the venting of 50-95% of the CO2. Collection into a single standardized collection vessel becomes a problem when the vessel holds less volume than is separated from a peak of interest and the vessel overfills with fractions. Prior methods for collecting a broad large-volume peak include truncating the collection prior to overfilling the available volume of the collection vessel or continuing to collect the fraction using a series of up to “n” number of unspecified collection vessels, which in further steps are dried down and recombined. Therefore, what is needed is an automated assembly to collect all of the solvent and solute mixture from a fraction into a single collection vessel.

### SUMMARY

There is described herein a preferred exemplary embodiment of an extended vessel assembly to that provides collection of substantially large volumes of liquid fractions from chromatography system, such as a preparatory scale supercritical fluid chromatography (“Prep Scale SFC”) or preparatory scale liquid chromatography (“Prep Scale LC”), into a single collection vessel having a volume smaller than the fraction collected from a peak. The invention allows a collection system to collect all of the solute/solvent mixture in a fraction into the extended vessel assembly, thereby collecting a substantially larger liquid volume than the collection vessel itself can retain. SFC is a preferred technology to reduce total solvent volume collected in a collection vessel so that recovery and purification of a sample fraction can be accomplished in a single collection device.

The vessel extender of the extended vessel assembly is suitable for increasing the total collectable volume of a liquid phase fraction from Prep Scale SFC or Prep Scale LC while using a relatively small collection vessel. The final collection vessel can be used throughout the entire purification and dry down process, including the final stages of re-solvating in dimethyl sulfoxide (“DMSO”) and storage. The invention improves productivity while reducing the need for sample transfer between vessels and reducing the risk of human error. The device of the preferred embodiment enables the use of a single collection/storage vessel to collect and hold a significantly larger liquid volume than the available volume of the vessel itself. The additional liquid volume is then reduced after purification collection using one of several types of evaporation devices or techniques, such as evaporation at moderate temperature under a vacuum with liquid agitation to minimize bumping.

The vessel extender can be applied to a range of vessel types and sizes. For example, a 1 Dram (4 mL) screw-cap vessel is a common vessel for final storage of purified, dried down, weighed compound which is then re-solvated in DMSO, capped and stored into a Compound Library Storage System. For such a 1 Dram screw-cap vessel, the vessel extender screws down snugly onto the vessel, forming a sealing or “near-sealing” contact onto a collection vessel. Further embodiments of the vessel extender can snap on to a crimp cap vessel or form an “interference fit” on the inner or outer diameter of a straight-walled collection vessel, such as a test tube.

The extended vessel assembly is well-suited for use in an automated collection system. Collection vessels could be bar coded and tared in an automated device such as a Mettler-Toledo AutoChem Label Automater prior to attachment of the vessel extender. The vessel extender could be assembled or disassembled from a series of collection vessels, either manually or with an automated capper/decapper device. The extended vessel assembly would then be mounted in a rack suitable for use in an automated fraction collector and moved to an evaporator module to evaporate the vessel down to dryness. The vessel extender would remain assembled through the dry down process. The vessel extender could then be decapped from the collection vessel either manually or automatically. After evaporation of liquid phase from the solute, a fully dried sample could then be weighed in an automated device such as the Mettler-Toledo AutoChem Automater, after which the purified, weighed compound could be re-solvated as appropriate for long-term storage prior to storage in a compound library storage system.

The system of the present invention can collect an entire fraction into a single extended vessel assembly and places the assembly into a rack. A rack of assemblies are then gathered and moved to an evaporator module to evaporate each vessel down to dryness.

The present invention greatly reduces the amount of hazardous solvents purchased, used, and disposed of by an analytical laboratory. Historically, preparatory and analytical SFC methods contribute to enhancing the quality of the environment by greatly reducing the amount of hazardous solvents purchased, used and disposed by an analytical chemistry laboratory. Historically, disposal of spent solvents have created many of the worst environmental problems in this nation. Solvents, such as methylene chloride, are typically purchased and used in many analytical laboratory methods to extract constituents of interest from a particular sample. Analytical and Pre Scale HPLC commonly uses a mixture of acetonitrile in water, which typically must be disposed of by incineration in an energy-intensive process. Laboratories using these chemicals not only release solvent into the ambient air as organic vapors vented from the laboratory, but also generate hundreds of gallons of spent solvents per month. Disposal of these spend solvents is often more expensive than the purchasing of the same solvents. Furthermore, in many cases the stored solvents are flammable, presenting an added safety hazard for unused and spent solvents stored in and near the laboratory environment.

In contrast to these solvent-intensive purification technologies, Analytical and Prep-Scale SFC offers the potential reduction of 83-99% in solvent utilization compared to a comparable scale of HPLC system. This is due to the combined effect of significantly shorter run times (3 to 10 fold) as well as the fact that during typical SFC gradient programs, somewhere between 50 to 95% of the mobile phase is supercritical CO2 as opposed to organic solvent. It can also be demonstrated that total energy consumption required for all purification and dry-down processes by Prep-Scale SFC can be reduced by over 95% compared to comparable Prep-Scale HPLC technology.

### BRIEF DESCRIPTION OF THE DRAWINGS

For a better understanding of the nature of the present invention, reference is had to the following figures and detailed description, wherein like elements are accorded like reference numerals, and wherein:

FIG. 1 is a flow diagram of a supercritical fluid chromatography system;

FIG. 2 is a cross-sectional view of an extended vessel assembly using a screw-cap extender for attachment;

FIG. 3 is a cross-sectional view of an extended vessel assembly with a restriction at the top end;

FIG. 4 is a cross-sectional view of an extended vessel assembly using a flange ring on the vessel extender for attachment to a collection vessel;

FIG. 5 is a cross-sectional view of an extended vessel assembly using a housing around a collection vessel for attachment.

FIG. 6 is a flowchart of the factory system of the preferred embodiment;

FIG. 7 is a cross-sectional view of an extended vessel assembly in a labeled rack.

### DETAILED DESCRIPTION OF PREFERRED EMBODIMENTS

There is described herein a preferred exemplary embodiment for a system of sample fraction collection and purification in chromatography, and more specifically for using a collection vessel in a factory system for purification of sample fractions in chromatography. The preferred embodiment may be implemented in chromatography systems that include supercritical fluid chromatography (SFC), such as preparatory scale (prep) or analytical SFC, and liquid chromatography (LC) such as preparatory scale LC or high performance liquid chromatography (HPLC). The system automates steps in the purification process with automated information links without the need to change the collection vessel holding purified compound. An individual collection vessel throughout the entire collection and purification process, including from the time a sample fraction is collected until it is fully dried down, is used throughout the entire process thereby avoiding transfer of samples to different containers and potential errors. As a result the system enables substantial increase in automation productivity with less need for human interaction and less risk of human error. To hold a purified compound, the system uses an extended vessel assembly (EVA), as described in co-pending application for a SAMPLE COLLECTION VESSEL EXTENDER FOR CHROMATOGRAPHIC SYSTEMS, which is assigned to the same assignee as the present application. The EVA enables the use of more collection volume than is otherwise available in the final storage vessel, and thereby eliminates the need for intermediate sample transfers between vessels or for recombining portions of the same fi-action that is collected into multiple collection vessels.

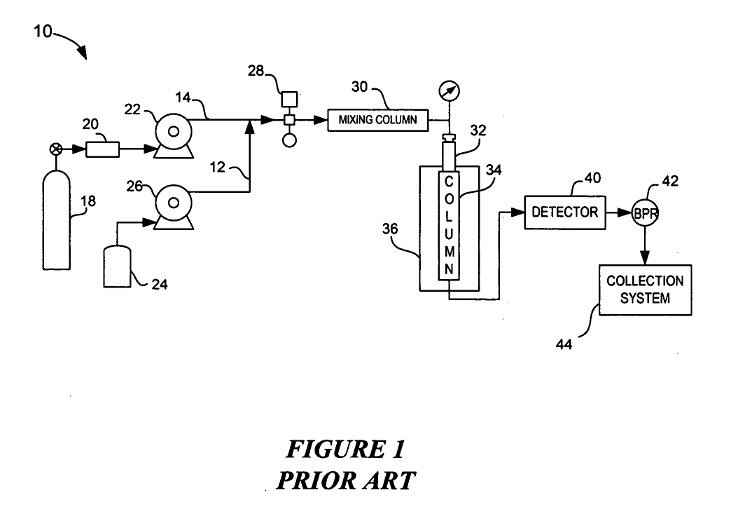

Components of an SFC system 10, upstream of a collection system, are illustrated in the schematic of FIG. 1. System 10 comprises two independent flow streams 12, 14 combining to form the mobile phase flow stream. In a typical SFC pumping assembly, a compressible fluid, such as carbon dioxide (CO2), is pumped under pressure to use as a supercritical solvating component of a mobile phase flow stream. Tank 18 supplies CO2 under pressure that is cooled by chiller 20. Due to precise pumping requirements, SFC systems commonly use an SFC-grade reciprocating piston pump 22 having dynamic compressibility compensation.

A second independent flow stream in the SFC system provides modifier solvent, which is typically methanol but can be a number of similar solvents suitable for use in SFC. Modifier is supplied from a supply tank 24 feeding a second high-grade pump for relatively incompressible fluids 26. Flow is combined into one mobile phase flow stream and passes through pressure regulator 28 prior to entering mixing column 30. The combined mobile phase is pumped at a controlled mass-flow rate from the mixing column 30 through transfer tubing to a fixed-loop injector 32 where a sample is injected into the flow stream.

The flow stream, containing sample solutes, then enters a chromatography column 34. Column 34 contains stationary phase that elutes a sample into its individual constituents for identification and analysis. Temperature of the column 34 is controlled by an oven 36. The flow rate should be kept as constant as possible through the separation column. If the flow rate fluctuates, variations in the retention time of the injected sample would occur such that the areas of the chromatographic peaks produced by a detector connected to the outlet of the column would vary. Since the peak areas are representative for the concentration of the chromatographically separated sample substance, fluctuations in the flow rate would impair the accuracy and the reproducibility of quantitative measurements. At high pressures, compressibility of solvents is very noticeable and failure to account for compressibility causes technical errors in analyses and separation in SFC.

The elution mixture leaving column 34 passes from the column outlet into detector 40. Detector 40 can vary depending upon the application, but common detectors are ultraviolet, flame ionization (with an injector- or post-column split), or mass spectrometry. After analysis through the detector 40, the mobile phase flow stream passes through a back-pressure regulator 42, which leads to a downstream sample fraction phase separation and collection system 44. The collection system 44 includes the equipment and processes for collecting liquid phase fractions from a mobile phase flow stream into a final collection vessel

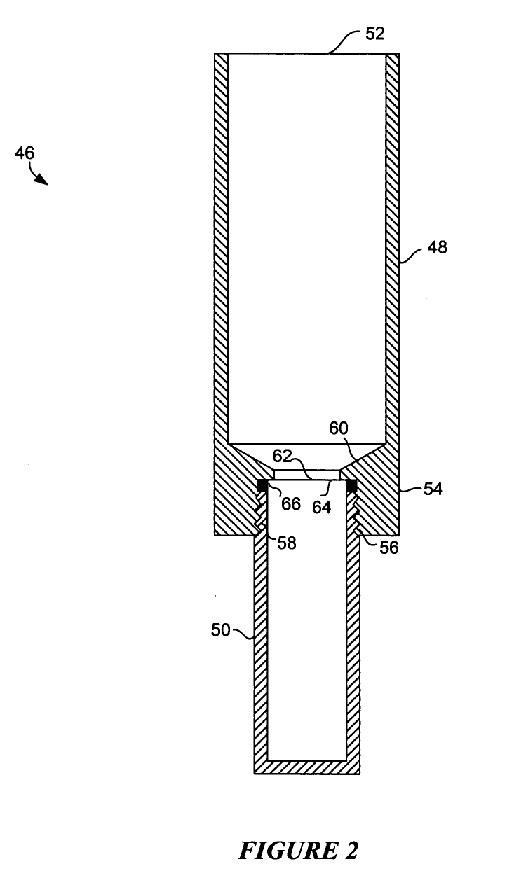

Reference is made to FIG. 2, illustrating a cross-sectional view of a preferred exemplary embodiment of an extended vessel assembly (EVA) 46. The vessel extender 48 attaches to a collection vessel 50 for collection of a wide dynamic range of fractions from peaks of chromatographically separated samples while using the same footprint as a single collection vessel. Vessel extender 48 is a generally hollow cylindrical vessel that receives liquid phase from a collection system 44 through the mouth 52 in the top end with a bottom end 54 designed for attaching to a collection vessel 50. Vessel extender 48 has female threads 56 at the attaching end for reception of male screw-cap threads 58 of collection vessel 50. While the exterior of the vessel extender 48 at the attaching end 54 retains its cylindrical shape, the interior 60 has a funnel-shaped reduced diameter so that liquids received from a sample fraction collection system 44 are directed into the relatively smaller volume collection vessel 50. The mouth 62 of the vessel extender at the bottom attaching 54 end may have the same or smaller inner diameter (ID) as the mouth at the top, screw-cap end 64 of the collection vessel 50. However, an equal ID of the two mouths 62, 64 creates a smooth-flowing stream and minimizes problems with a restriction between the two pieces and turbulence in the collection vessel 50.

In the preferred embodiment, one example of a collection vessel 50 is a 1-Dram (4 mL) screw-cap vessel that is commonly used in prep SFC for sample collection and storage. As one skilled in the art will recognize, the sizes and shapes of EVAs are exemplary and exact sizes, shapes, and structures of EVAs and collection vessels may vary without exceeding the scope of the inventive concept taught herein. In FIG. 2, a vessel extender 48 is attached on top of collection vessel 50. The bottom end 54 of a vessel extender 48 screws onto the top end 64 of a collection vessel 50 which forms a liquid-proof seal. The resulting EVA 46 provides for temporary filling of the collection vessel 50 beyond the volume of the collection vessel itself.

When collecting a purified compound by Prep SFC or Prep LC, the collection of a total peak into a single collection vessel may not be possible. This is typically the case when collecting a broad solute peak at a relatively late point in a gradient elution by Prep SFC. At a 40% to 50% ratio of modifier to compressible fluid flow in a Prep SFC mobile phase flow stream operating at 50 mL/min, a 1 minute wide peak would correct approximately 20 to 25 mL of liquid volume. At these gradient conditions, a peak that is ½ or ¼ minute wide will result in a collection volume of approximately 5 to 13 mL of liquid volume, all exceeding the capacity of a single 1 Dram (4 nlL) collection vessel. Using a vessel extender 48 and collection vessel 50 that are appropriately sized for the type of chromatography, liquid phase from an entire chromatographic peak may be collected into a single EVA 46. For example, compared to the volume of collection vessel 50 the volume of collection liquid phase fractions that can be collected is expanded by a factor of ten, making it possible for a 4 mL vessel to temporarily hold up to 40 mL of liquid, with an appropriately-sized vessel extender 48.

The connection between a collection vessel 50 and a vessel extender 48 should seal liquids sufficiently to contain the liquid held in the EVA 46. The sealing contact should be adequate to minimize solvent/solute leakage out of the assembly when filled with liquid beyond the capacity of the collection vessel 46. The exemplary EVA 46 in FIG. 2 has female threads 56 that receive the male threads 58 on collection vessel 50. A seal 66 optionally added to the vessel extender to fit against the collection vessel 50 when engaged with vessel extender 48. Various sealing mechanisms can provide an appropriate seal. A sealing surface could rely on an elastomeric O-ring or gasket, a semi-compliant gasket such as a polytetrafluoroethylene (PTFE) disc or seal, or on a direct seal between the vessel extender 48 and the collection vessel 50 surfaces. When implementing the assembly with an elastomeric seal, it is important that such a material be selected that will be inert and compatible in the solvent/solute environment to which it is exposed.

A vessel extender 48 may be designed as a single-use throwaway consumable or designed for multiple uses. If vessel extender 48 is designed for single or few uses or designed for applications that will infrequently fill the collection vessel 50 beyond its volumetric capacity, then addition of an elastomeric seal is merely optional. In such cases, the vessel extender 48 is designed to either directly form a seal to the collection vessel surface or seal with an inter-mediate, consumable “compliant seal disc” constructed of chemically inert and resistant materials such as PTFE or PEEK. Further designs of a consumable compliant seal include a chevron and ferrule type seal.

The vessel extender 48 of the preferred embodiment may be fabricated from an inert plastic material, preferably a material that is not significantly hydroscopic and one amenable to injection molding into final form without compromising other material properties of the extender. Possible materials for fabrication of the vessel extender include PTFE, Victrex PEEK polymer (PEEK), polypropylene, polyethylene, and polyurethane. The fabrication material and process should be carefully selected such that material or process fabrication contaminants, such as mold release, do not jeopardize the use of the vessel extender as part of a purification system. Vessel extenders may be fabricated with special chemical processes or surface treatments and coatings prior to use in the collection system 44 to ensure the highest possible inertness.

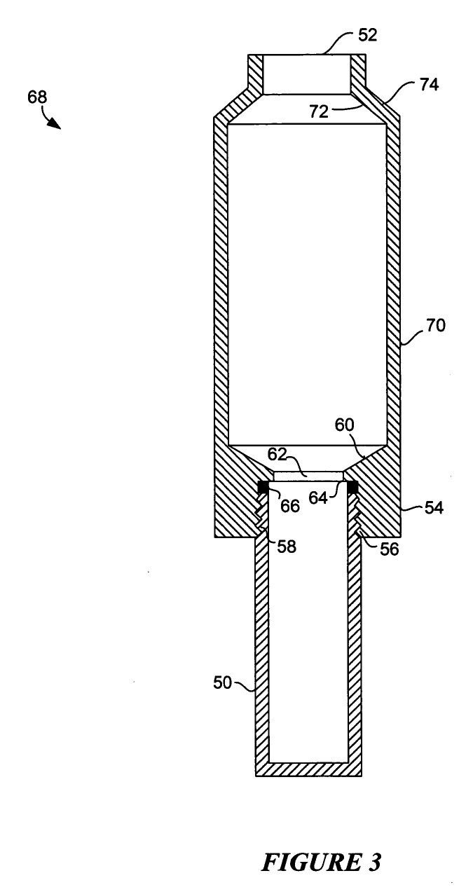

Alternative embodiments of the extended vessel assembly are illustrated in FIGS. 3, 4, and 5. A cross-sectional view of an alternative embodiment of an EVA 68 is illustrated in FIG. 3. The vessel extender 70 of the alternative embodiment is a generally hollow cylindrical vessel that receives liquid phase from the collection system 44 through the top receiving end 52 with a bottom end 54 designed for attaching to collection vessel 50. The top, receiving end 52 of the alternative vessel extender has a funnel-shaped reduced diameter on the interior 72 and exterior 74 of the vessel extender. This shape provides adequate space for flow into the vessel extender 70 from a collection system 44 and for a robotic arm or other automated device to reach into a tightly-packed rack of EVAs 68 and grab the top end of the vessel extender 52 without contacting vessel extenders of neighboring EVAs. Vessel extender 70 has female threads 56 at the attaching end 54 for reception of male screw-cap threads 58 of collection vessel 50. While the exterior of the vessel extender 70 at the attaching end 54 retains its cylindrical shape, the interior has a funnel-shaped reduced diameter 60 so that liquids received into the top end 52 from a sample fraction collection system 44 are directed into the relatively smaller volume collection vessel 50. The mouth of the vessel extender 62 at the bottom attaching end 54 should have the same or smaller BD as the mouth 64 of collection vessel 50. However, an equal ID of the two mouths 62, 64 creates a smooth-flowing stream and minimizes problems with a restriction between the two pieces and turbulence in the collection vessel 50.

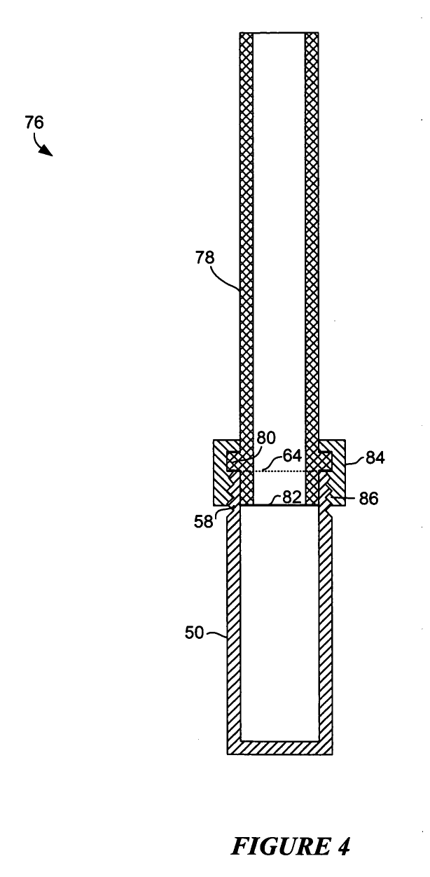

FIG. 4 illustrates a cross-sectional view of an additional embodiment of an EVA 76. Vessel extender 78 is generally hollow and has a cylindrically shaped interior and cylindrical exterior except for an external flange 80 on the outside of the extender near the attachment end. Vessel extender 78 attaches to a 1 Dram collection vessel 50 with a female threaded coupling 84 which secures flange ring 80 and male threads 58. Coupling 84 holds flange 80 securely in a groove and screws onto the collection vessel's male threads 56 with female threads 86 until rim of mouth 64 abuts the bottom of flange 80. Once attached, mouth 82 of the vessel extender 78 extends into the collection vessel 50 but is stopped by the bottom of flange 80 contacting the top rim 64 of collection vessel 50. The EVA 76 in FIG. 4 has an axial cross-sectional area only slightly larger than the collection vessel 50 itself, which allows a greater packing density of EVAs 76 into a rack or other storage unit.

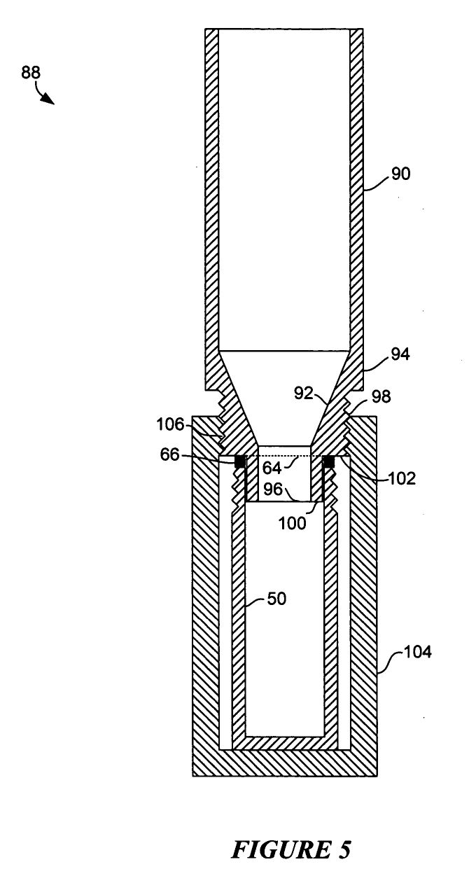

FIG. 5 illustrates a cross-sectional view of an additional embodiment of an EVA 88 secured with an interference fit on the inner or outer diameter of a straight-walled collection vessel 50. The interior of the vessel extender 90 is funnel-shaped 92 at the attaching end 94 so that liquids from a collection system 44 can be directed into a relatively smaller collection vessel 50. The vessel extender 90 is generally cylindrical and has a tiered outer profile at the attachment end 94. A first tier 98 has a series of male threads. The second tier 100 is smooth and forms the mouth 96 of the vessel extender 90. Vessel extender mouth 96 should have a smaller outer diameter than the ID of collection vessel mouth 64 because vessel extender mouth 96 extends into the collection vessel 50. Collection vessel mouth 96 is stopped by flanged surface 102 contacting the rim of collection vessel mouth 64.

The collection vessel 50 is held inside of a housing 104 that is closed on all sides except the top attaching end. The attaching end of the housing has a series of internal female threads 106 that form a threaded seal when the housing receives the male threads on first tier 98. Seal 66 may be placed between the top rim of a collection vessel mouth 64 and below the first tier flanged surface 102. The sealing contact should be adequate to minimize solvent/solute leakage out of the EVA 88 when filled with liquid beyond the capacity of the collection vessel 50. This alternative embodiment has a broader application for attaching a vessel extender 90 to a collection vessel 50 because the extender can work with any straight-walled vessel 50 that is suitable for liquid fraction collection in an SFC or LC system, for example a test tube.

The extended vessel assembly is well-suited for use in an automated collection system. Collection vessels could be bar coded and tared in an automated device such as a Mettler-Toledo Bohdan Label Automater prior to attachment of the vessel extender. The vessel extender could be assembled or disassembled from a series of collection vessels, either manually or with an automated capper/decapper device. The extended vessel assembly would then be mounted in a rack suitable for use in an automated fi-action collector and moved to an evaporator module to evaporate the contents of the vessel down to dryness. The vessel extender would remain assembled through the dry down process. The vessel extender could then be decapped from the collection vessel either manually or automatically. After evaporation of liquid phase from the solute fully dried sample could then be weighed in an automated device such as the Mettler-Toledo Bohdan Balance Automater, after which the purified, weighed compound could be re-solvated as appropriate for long-term storage prior to storage in a compound library storage system, or simply capped and stored in dry form.

The present invention is well suited for use in liquid or supercritical fluid preparatory scale chromatography systems that separate and collect liquid phase fractions. As one skilled in the art will recognize, the invention may be used in any chromatography system, especially in processes where it is necessary to retain a high percentage of sample fractions from an injected sample into a collection vessel. The invention improves productivity while reducing the need for sample transfer between vessels and reducing the risk of human error.

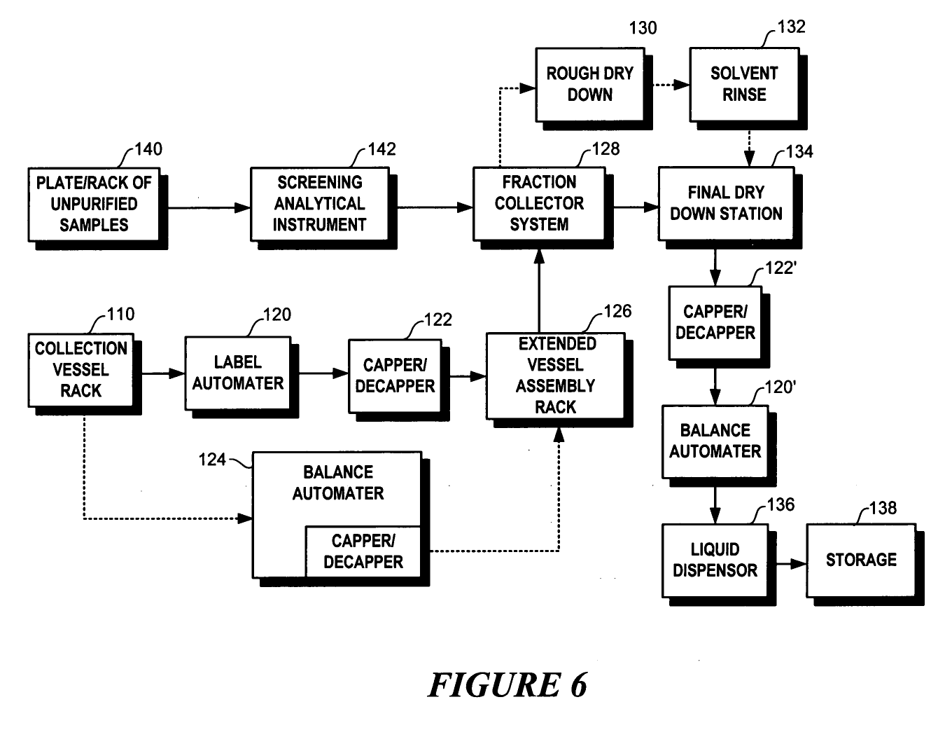

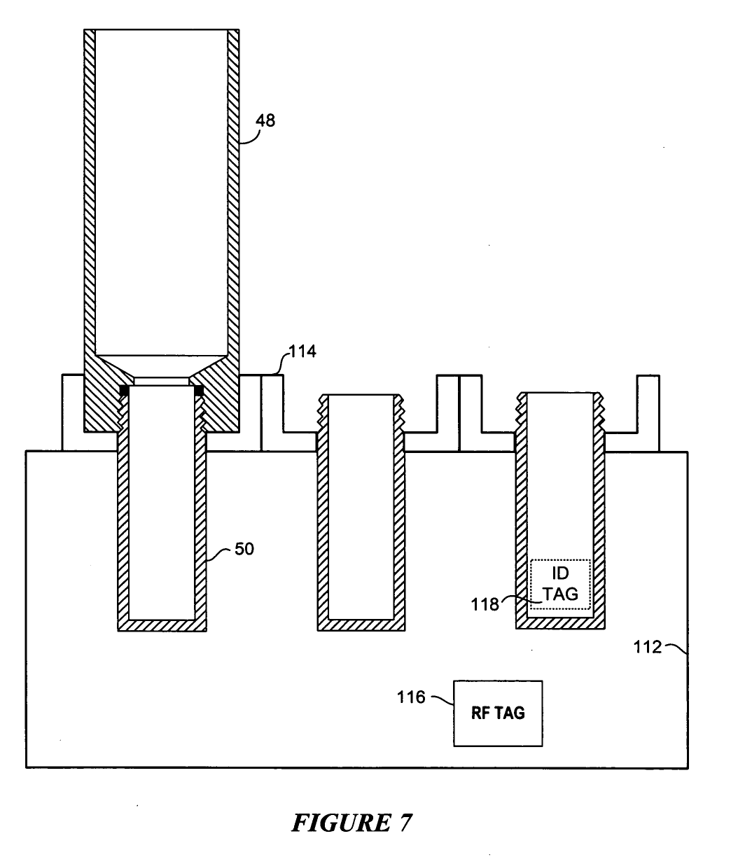

Referring to the flowchart in FIG. 6, the first step in the preferred embodiment of the pharmaceutical combi-chem purification factory system begins with placing collection vessels into a collection vessel rack 110. A rack is the preferred format in the system to move collection vessels between automated stations. A simplified diagram of a rack is illustrated in FIG. 7. Collection vessels 50 are contained and transported into rack 112. Rack 112 can be formatted to the dimensions of a ninety-six well plate or any format suitable for an automated chromatography system. The preferred embodiment uses screw-cap collection vessels placed into rack 112 along with guides 114 to assist proper placement of vessel extenders, such as the vessel extender 48 with a screw-cap threaded connection to a collection vessel 50. Along with a family of collection vessel extenders having internal volumes ranging from 8 to 40 mL, a rack of extended vessel assemblies are suitable for collecting a wide range of Prep SFC or Prep LC fractions into a single EVA. Depending on the actual size of the collection vessel and vessel extender selected, the capacity of a rack 112 to hold EVAs can vary. For example, a single rack may hold 12, 24, 32, 48 or some other number of EVAs. As one skilled in the art will recognize, rack and vessel sizes and capacities are exemplary, and exact sizes and capacities of racks and vessels can vary depending on the system designs.

Referring again to the flow chart of FIG. 6, the factory system continues with an automated collection vessel labeling/taring on a balance automator 120, such as the Mettler-Toledo Bohdan Label Automator. On this system, the collection vessels, prior to installation of a vessel extender, are bar-code labeled and tared. Alternatives to bar-coding include pre-labeling or pre-etching collection vessels with identifying information. An alternative or supplemental labeling scheme is to incorporate a memory device such as an identification tag 116 in or on the vessel 50. Collection vessels are mounted in racks suitable for use in an automated fraction collector. To simplify sample tracking, “racks” of collection vessel racks incorporate either a bar code or other identifying means, such as radio frequency tags 116 on each rack, to provide for automated sample tracking throughout all process steps.

The next step in the system is an automated Capper/Decapper (Capper) device 122. The Capper may be incorporated into the Label Automator 124 or remain a separate module, depending on the impact on efficiency and throughput. In either design configuration, the Capper 122 assembles a vessel extender onto a collection vessel, thereby converting a collection vessel into an “extended vessel assembly.” To assemble the EVAs with vessel extenders having threaded connections such as EVA 126, Capper 122 removes a collection vessel 50 from a rack 112, aligns the collection vessel 50 with a vessel extender 48, and threads the two together to an appropriate torque level. After assembly, Capper 122 returns the EVA 46 to the appropriate position in a rack containing only EVAs 126. Following the “capping” process, racks of EVAs are loaded into the fraction collector system 128.

Parallel to the Balance Automator 120 and Capper 122 stations, a Screening Analytical Instrument, such as SFC, LC, SFC-MS (mass spectrometry), or LC-MS performs an analytical run on each well in plates of samples waiting to be “prepped.” Based on the results of this screening run, plus algorithmic rules and parameters set by the user, a “Linking Software” application will determine which samples to collect on the prep system and how to optimize prep collection parameters for high purity and recovery. An exemplary sample input format used on the screening system is a 96-well plate of unpurified sample 140. An alternative sample input format includes racks of individual sample vials. For ease of sample tracking, the racks 140 of sample plates or racks of sample vials are incorporated into the bar code or other identification means that is placed onto each plate which allows for automated sample tracking throughout all the process steps. After all screening runs are complete, sample plates or racks of sample vials are loaded into the Prep SFC or Prep LC Fraction Collector System.

The Fraction Collector System 128 has multiple embodiments using the EVA, either at atmospheric pressure conditions or under modest head pressure. For routine Prep LC collection, the EVA should be adaptable to work with the vast majority of fraction collector products available in the marketplace. When utilized with Prep SFC, a Fraction Collector 128 that is coupled to a Mettler-Toledo Berger Separator Module can perform collection at atmospheric pressure conditions or under modest head pressure, such as 2 to 4 bar, to somewhat reduce the velocity of expanding carbon dioxide (“CO2”). The design of the Fraction Collection System 128 will depend on a combination of chromatographic parameters and collection parameters. For example, for prep scale chromatography involving 2 cm or 3 cm diameter columns, total flow rates of 50 to 100 L/min or higher is necessary. Collecting relatively large fi-actions under these flow conditions would optimally use a 2 to 4 bar pressure scheme maintained in an EVA to ensure full containment of the collected sample with minimum losses due to aerosol formation. However if the system is scaled around a 1 cm or 16 mm prep column with total column flowrates of 20 to 40 mL/min, fractions may be collected at atmospheric conditions using the appropriate EVA, i.e. selecting the appropriate “Total volume” EVA.

After the fraction collection 128, racks of EVAs are transferred to a Rough Dry Down 130 station that evaporates the collection vessel down to dryness. In the case of Prep LC, the dry down procedure can be performed using a large centrifugal vacuum evaporator such as those manufactured by Genovac or Savant. In the case of Prep SFC using a relatively volatile organic solvent, such as methanol, as a modifier in the mobile phase flow stream, the dry down process can be performed using an evaporator under an appropriate vacuum, with the racks of EVAs agitated suitably to minimize “bumping.” The solvent may be gently heated but is not boiled. The evaporator can incorporate a temperature control at a modest setting, such as 30 to 35C. Examples of agitation devices include a vortex mixer, or alternatively an ultrasonic energy source. In most non-automated techniques, the collection device's walls would be rinsed manually, however in automation rinsing is a more difficult process. By agitating the solvent in the EVA, a substantial amount of loss of purified compound in the vessel extender is prevented. In cases where the EVA has been filled substantially beyond the volume of the collection vessel itself, a rough drying process may be required prior to the dry down process to receive the highest possible recovery.

Agitation is performed in the dry down process not only to prevent bumping, but also to provide a larger surface area for evaporation, which is an advantage of vortexing over sonicating. Vortexing reduces the severity of bumping but increases the surface area. Without vortexing, substantial agitation does not occur in the EVA and the surface can become concentrated, which reduces the vapor pressure due to a concentration of insoluble material on the top surface.

The dry down evaporation process 130 may leave behind a residue of purified compound on the inner wall or sides of the vessel extender. In typical automation, between five and fifteen percent of a compound can be lost per transfer between vessels or automated stations. The materials recovered from many prep scale chromatography applications are very valuable, and therefore an elimination of losses, especially after a purification step has already been performed such as at the dry down station, is highly desirable and profitable. If residual loss in the vessel extender occurs, the EVAs may be subjected to a solvent rinsing stage 132 that is performed after rough evaporation 130 but prior to the final dry down evaporation 134. The solvent rinsing station 132 dispenses methanol, or an equivalent solvent; into an EVA and performs a circular flushing on the inner the walls of the vessel extender, thereby removing compound residue from the walls of the extender and draining the solvent rinse into the collection vessel. The final dry drown process 134 would then proceed in the EVA.

Following final dry down 134, the racks of EVAs are returned to the Capper/Decapper 122 and the vessel extender is removed from the collection vessel. The vessel extender can be processed through a wash cycle and reused again for a number of system cycles, or discarded.

The fully dried samples in collection vessels are then weighed in the same automated Label Automator 120′ used initially to tare the vessels, such as the exemplary Mettler-Toledo Label Automator. If the Capper 122′ and Label Automator 120′ are combined into a single station 124 then collection vessels are moved to one station instead of two.

The final system process steps are performed by moving the racks of collection vessels into a liquid dispensing station 136, where each dried down sample is re-solvated as appropriate for long term storage. An example of a solvent used for storage is dimethyl sulfoxide, or DMSO. The collection vessels are automatically capped, for example, with screw caps prior to storage. The racks of re-solvated and capped purified compounds are finally transported to the compound library storage/retrieval system 138.

The present invention is well suited for use in liquid or supercritical fluid preparatory scale chromatography systems that separate and collect liquid phase fractions. As one skilled in the art will recognize, the invention may be used in any chromatography system, especially in processes where it is necessary retain a high percentage of sample fractions from an injected sample into a collection vessel. The invention improves productivity while reducing the need for sample transfer between vessels and reducing the risk of human error.

Because many varying and different embodiments may be made within the scope of the inventive concept herein taught, and because many modifications may be made in the embodiments herein detailed in accordance with the descriptive requirements of the law, it is to be understood that the details herein are to be interpreted as illustrative and not in a limiting sense.

What is claimed:

1. A process for purification of a sample fraction from a chromatographic flow stream, comprising:
attaching a vessel extender to a collection vessel to form an extended vessel assembly such that the flow stream enters the vessel extender and into the collection vessel;
collecting the flow stream into the extended vessel assembly; and
evaporating liquid solvent from the extended vessel assembly in a dry down process.

2. The process of claim 1, further comprising:
mounting a plurality of the vessel assemblies in a rack for transportation within sample purification system.

3. The process of claim 1, further comprising:
determining the amount of purified compound in each collection vessel, comprising:
weighing an empty collection vessel prior to attaching the vessel extender; and
re-weighing the collection vessel after the dry down process and removal of the vessel extender.

4. The process of claim 1, further comprising:
labeling the collection vessel for tracking through the purification process using one of the following methods: bar-coding, pre-labeling, pre-etching, or a memory device such as a radio frequency tag.

5. The process of claim 1, wherein the attaching a vessel extender comprises attaching with an automated capper/decapper device that automatically attaches the vessel extender to the collection vessel.

6. The process of claim 1, wherein the collecting the sample fractions into the extended vessel assembly is performed using a fraction collector system operating at either atmospheric conditions or under a head pressure.

7. The process of claim 1, wherein said evaporating solvent from the vessel assembly in the dry down process comprises evaporating with at least one of a centrifugal vacuum evaporator, modest heat applied to the assembly, and agitation of vessel contents under a vacuum.

8. The process of claim 1, wherein, after said collecting said flow stream, a racks of extended vessel assemblies are transferred to a rough dry down station that evaporates the vessel assemblies down to dryness.

9. The process of claim 8, further comprising:
rinsing the vessel extender with a solvent after the rough dry down process and before the dry down process to remove residue of purified compound remaining on the vessel extender into the collection vessel.

10. The process of claim 8, further comprising:
re-solvating the collection vessel by dispensing liquid solvent into the collection vessel.

11. A system for purification of a sample fraction from a chromatographic flow stream, comprising:
a collection vessel for collecting liquid phase from the flow stream;
a vessel extender attached to the collection vessel to form an extended vessel assembly for storage of sample fractions from the flow stream;
a fraction collector system to collect the sample fractions from the flow stream into the extended vessel assembly.

12. The system of claim 11, further comprising:
a dry down station that evaporates the sample fractions from the extended vessel assembly in a dry down process.

13. The system of claim 12, further comprising:
a balance automator to determine amount of purified compound remaining in the collection vessel after the dry down process by weighing the collection vessel holding the dried purified compound.

14. The system of claim 11, further comprising:
a liquid dispensing module wherein a preservative is placed in the collection vessel after weighing in a balance automator.

15. The system of claim 11, further comprising:
a capper/decapper module for removing and replacing the vessel extender from the collection vessel.
